(19) United States
(12) Patent Application Publication
(10) Pub. No.: US 2017/0305681 A1
(43) Pub. Date: Oct. 26, 2017

(54) POWERED WHEEL ASSEBMLY FOR AN AUGER ASSEMBLY

(71) Applicant: Kramble Industries Inc., Saskatoon (CA)

(72) Inventors: Douglas James Kramble, Saskatoon (CA); Alan Reid, Tees (CA)

(73) Assignee: Kramble Industries Inc., Saskatoon (CA)

(21) Appl. No.: 15/139,067

(22) Filed: Apr. 26, 2016

(51) Int. Cl. B65G 41/00; B60K 7/00; B65G 33/24; B65G 33/14

(52) U.S. Cl. CPC B65G 41/008; B65G 33/24; B60K 7/0007; B65G 33/14

(57) ABSTRACT

A powered wheel assembly for an auger assembly is provided. The wheel assembly comprises a power source support structure configured for attachment to the auger assembly and a power source for providing a rotational force to a weight-load supporting wheel of the auger assembly. Actuating the power source causes the weight-load supporting wheel of the auger assembly to rotate and displace the auger assembly when the power source support structure is attached to the auger assembly.

### TECHNICAL FIELD

The present invention relates to wheel assemblies, and more particularly to wheel assemblies for auger assemblies.

### BACKGROUND

Conventional auger assemblies include an auger tube with an auger screw inside the tube. These assemblies typically have ground-engaging wheels that are centrally disposed to bear the weight load of the assembly and facilitate its transportation. The auger assemblies may also include distal ground-engaging wheels at an end of the auger tube for facilitating transportation. However, auger assemblies are usually very heavy in weight and difficult to move. Safety concerns are generally an issue during the movement of auger assemblies.

Various strategies have been disclosed in the prior art that deal with facilitating the movement of auger assemblies. For example, Vaughn discloses an auger assembly moving device in U.S. Pat. Nos. 4,359,117 and 4,650,058 that involves motorized wheels to facilitate the movement of auger assemblies. These auger assemblies are, however, structurally complex and are arguably expensive to implement. Furthermore, several of the embodiments described rely on the power source that is used to power the auger screw. Vaughn also discloses in several embodiments that steering must be done manually. This raises both safety and convenience concerns.

What is needed, therefore, is a means for moving heavy auger assemblies with ease of transport and wherein safety concerns are addressed.

### SUMMARY

According to a broad aspect of the present invention there is provided a powered wheel assembly for an auger assembly, the auger assembly comprising an auger tube with an auger screw therein, a wheel support, and at least one weight-load supporting wheel rotatably mounted on the wheel support, the wheel assembly comprising:

a power source support structure configured for attachment to the auger assembly; and

at least one power source for mounting on the power source support structure and providing a rotational force to the at least one weight-load supporting wheel;

such that actuating the at least one power source causes the at least one weight-load supporting wheel to rotate and displace the auger assembly when the power source support structure is attached to the auger assembly.

In some exemplary embodiments of the present invention, the auger assembly comprises at least two weight-load supporting wheels. Preferably, the at least two weight-load supporting wheels would be powered by separate power sources.

In some embodiments, the power sources for the two weight-load supporting wheels provide a rotational force independent from each other, provide a rotational force independent from the auger assembly's power source, are capable of providing a rotational force in two directions, and/or are capable of providing a rotational force such that the weight-load supporting wheels can rotate at variable speeds.

Optionally, the at least two weight-load supporting wheels are powered by a single power source.

Optionally, only one of the at least two weight-load supporting wheels are powered by a power source.

Preferably, the at least one power source for providing a rotational force to the at least one weight-load supporting wheel is controlled by remote control.

In some exemplary embodiments of the present invention, the at least one power source for providing a rotational force to the at least one weight-load supporting wheel is a gas motor or an electric motor. Preferably, the at least one power source is an electric motor that is battery operated.

In some exemplary embodiments of the present invention, the powered wheel assembly further comprises at least one rotational force transfer member, the at least one rotational force transfer members configured to transfer the rotational force provided by the at least one power source to the at least one weight-load supporting wheel. Preferably, the at least one rotational force transfer member comprises a gear assembly.

A detailed description of an exemplary embodiment of the present invention is given in the following. It is to be understood, however, that the invention is not to be construed as being limited to this embodiment.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

In the accompanying drawings, which illustrate an exemplary embodiment of the present invention:

FIG. 1 is a front perspective view of an auger assembly and powered wheel assembly according to the present invention;

FIGS. 2a to 2d are views of an exemplary power source according to the present invention;

FIGS. 3a and 3b are photographs of a power source connected to a wheel according to an exemplary embodiment of the present invention; and

FIG. 4 is a photograph of a rotational force transfer member according to an exemplary embodiment of the present invention.

An exemplary embodiment of the present invention will now be described with reference to the accompanying drawings.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Referring now to the accompanying drawings, an embodiment of an assembly according to the present invention is illustrated. It is to be understood that the illustrated embodiment is exemplary only and other embodiments may properly fall within the scope of the claims.

The present invention is directed to powered wheel assemblies which provide a power source for rotating an auger assembly's wheels thus displacing the auger assembly.

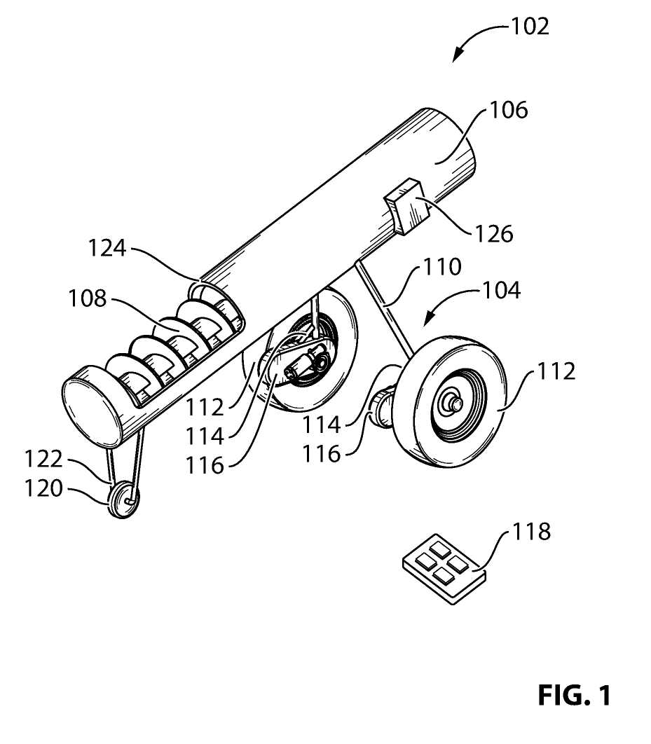

Turning to FIG. 1, a first embodiment of the present invention is illustrated. An auger assembly 102 is shown which has an elongated auger tube 106 and an auger screw 108 within the tube 106. The tube 106 is mounted on wheel supports 110 that are each connected to a weight-load supporting wheel 112 that engages with the ground. The wheel supports 110 and weight-load supporting wheels 112 are positioned in a manner on the auger tube 106 such that the wheels 112 support a substantial portion of the weight of the auger assembly 102. Typically, they are positioned around the central region of the auger tube 106. Conventionally, the auger assembly 102 has at least one ground engaging distal wheel 120 and wheel support member 122 at a distal end 124 of the auger tube 106 for both bearing some of the weight load of the auger assembly 102 and facilitating movement of the assembly 102.

A powered wheel assembly 104 is also shown in FIG. 1. The powered wheel assembly 104 shown has two power sources 116 that are attached to the auger assembly 102 via a pair of power-source support structures 114 that are configured for attachment to the auger assembly 102. The power sources 116 may be, but are not limited to, a gas motor or an electric motor. One skilled in the art would be able to determine other power sources appropriate and suitable for the present invention. Preferably, the wheel assembly power sources 116 are independent from the conventional auger assembly power source 126. The wheel assembly power sources 116 provide a rotational force to the weight-load supporting wheels 112. As shown in FIG. 1, each weight-load supporting wheel 112 receives a rotational force from a separate wheel assembly power source 116, but it is within the scope of the present invention for a single wheel assembly power source 116 to provide power to both ground-engaging wheels 112.

In the exemplary embodiment, the power sources 116 for the weight-load supporting wheels 112 provide a rotational force independent from each other and provide a rotational force independent from the auger assembly's power source 126. Each power source 116 is capable of providing a rotational force in two directions and providing a rotational force such that the weight-load supporting wheels 112 can rotate at variable speeds. Thus, the auger assembly 102 could be moved forwardly, rearwardly, or turned left or right by different direction or speed of the wheel 112 rotation.

In the exemplary embodiment, the power sources 116 for the weight-load supporting wheels 112 are controlled by a user employing a remote control 118. A person skilled in the art would know of commercially available remote control technologies suitable for application to embodiments of the present invention.

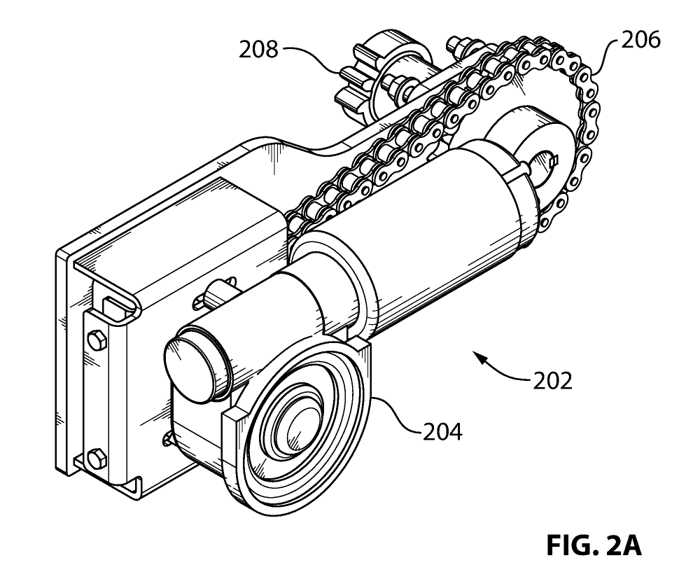

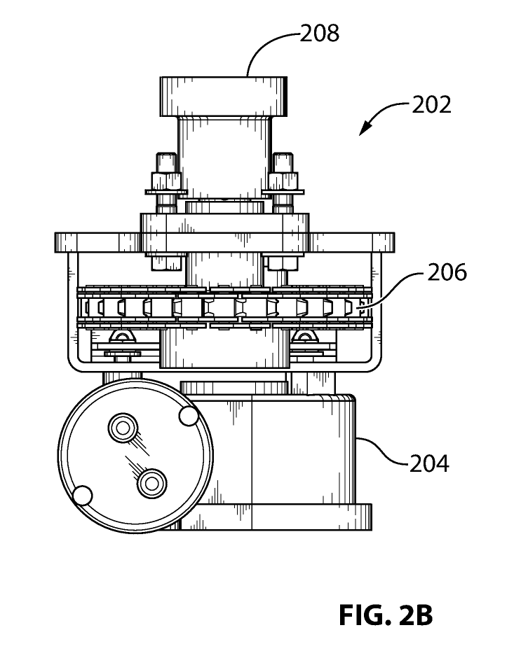

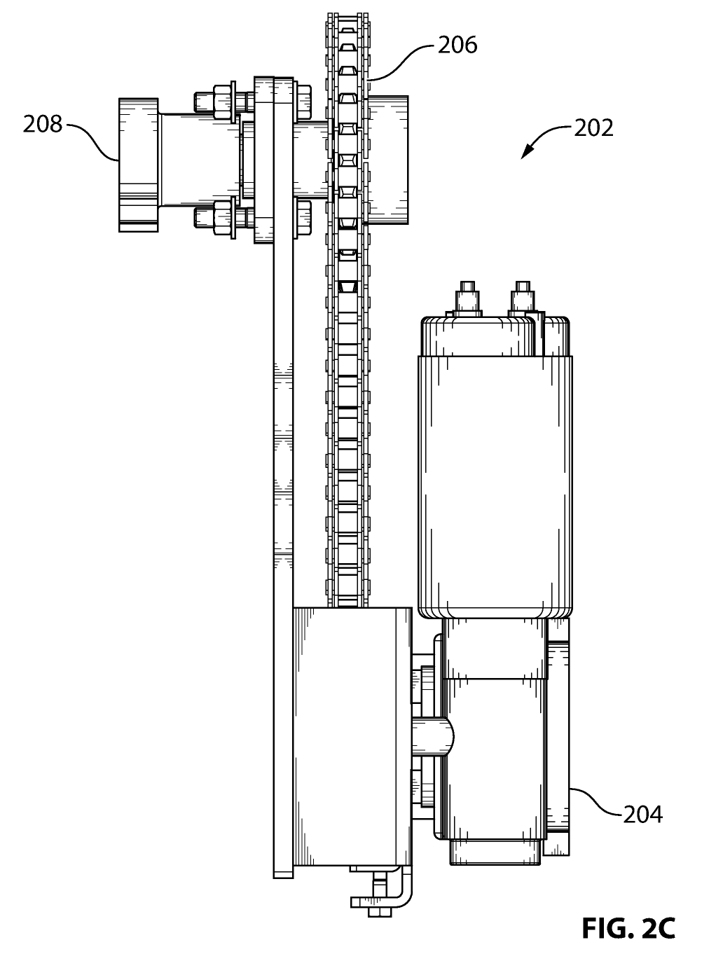

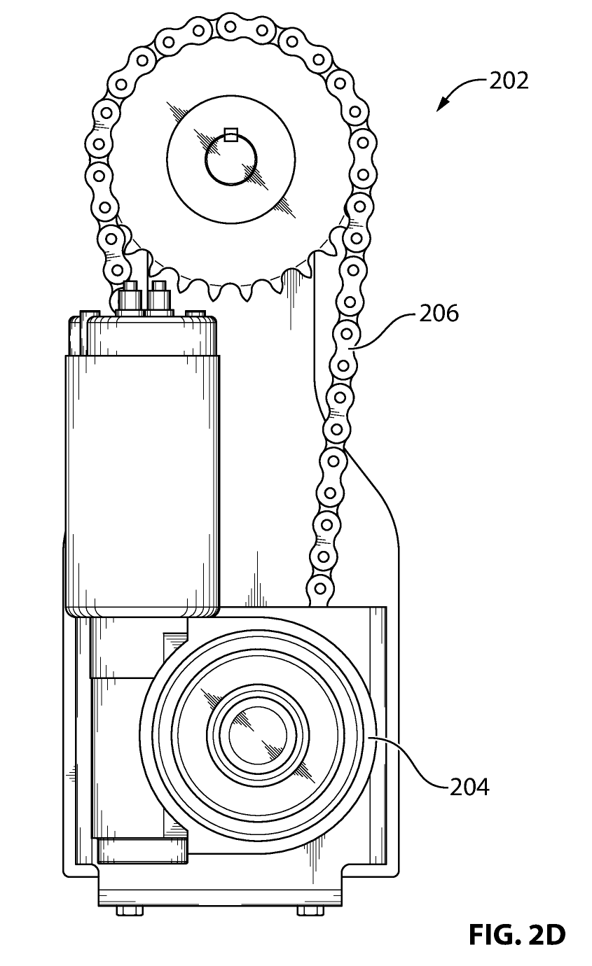

Turning to FIGS. 2a to 2d, a wheel assembly power source 202 is shown, which could be used as one form of the power sources 116 illustrated in FIG. 1 and described above. The power source 202 comprises an electric motor 204 that is rotatably attached to a chain drive 206, which in turn is connected to a drive shaft 208. In operation, when the motor 204 is actuated it causes the drive shaft 208 to rotate, and thus when the drive shaft 208 is rotating and is operably connected to a wheel it causes the wheel to rotate.

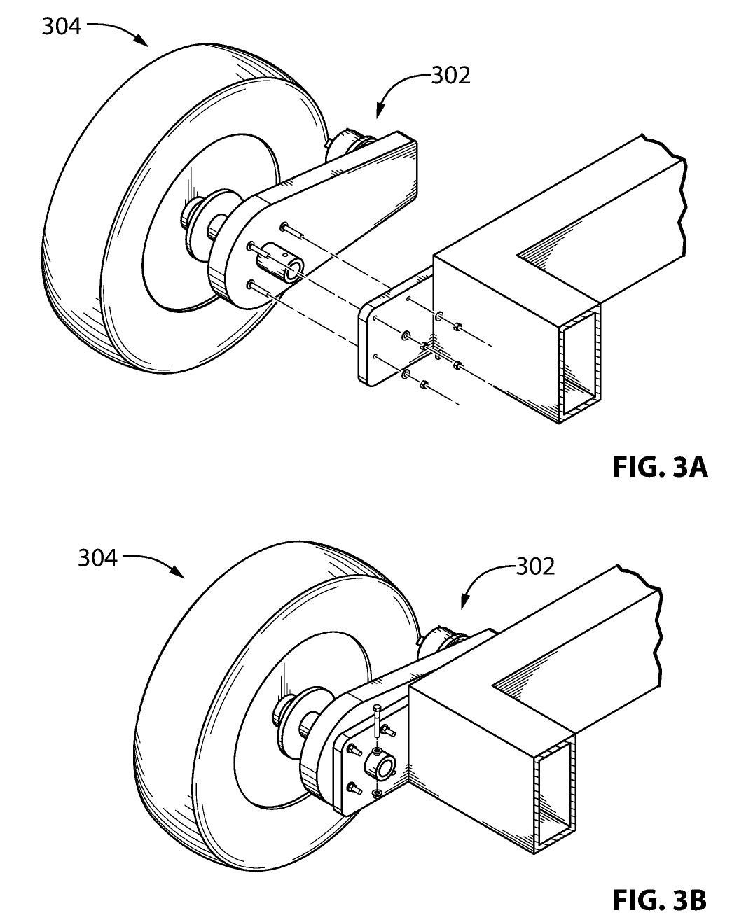

Turning to FIGS. 3a and 3b, a power source 302 is shown connected directly to a wheel 304.

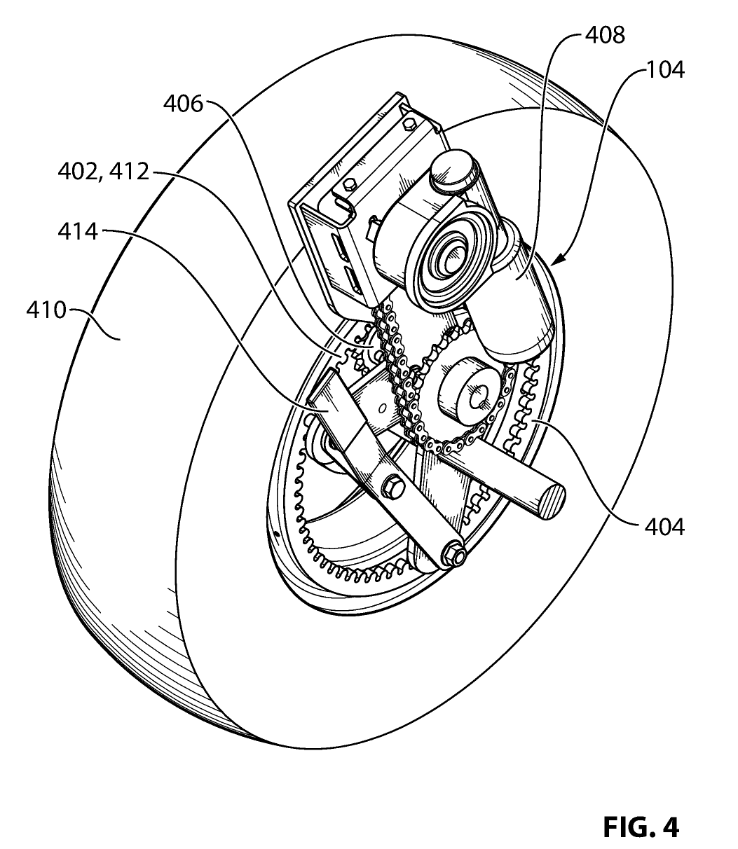

Turning to FIG. 4, the powered wheel assembly 104 may further comprise one or two rotational force transfer members 402. The rotational force transfer members 402 transfer the rotational force provided by each power source 408 to a weight-load supporting wheel 410. Preferably, the force transfer member is, but is not limited to, a gear assembly 412 having a gear hub 404 and gear member 406. One skilled in the art would be able to determine other various means for transferring the rotational force provided by each power source to the weight-load supporting wheels 410. The powered wheel assembly may also comprise an engaging means 414 for engaging and disengaging a force transfer member 402 from a weight-load supporting wheel 410.

In operation, actuating the power sources 116 shown in FIG. 1 causes each weight-load supporting wheel 112 to rotate and displace the auger assembly 102 when the power source support structure 114 is attached to the auger assembly 102. Each power source 116 can provide rotational force in opposite directions causing auger assembly 102 to pivotally turn. Preferably, each power source 116 is operated by remote control 118.

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”.
“connected”, “coupled”, or any variant thereof, means any connection or coupling, either direct or indirect, between two or more elements; the coupling or connection between the elements can be physical, logical, or a combination thereof
“herein”, “above”, “below”, and words of similar import, when used to describe this specification shall refer to this specification as a whole and not to any particular portions of this specification.
“or”, in reference to a list of two or more items, covers all of the following interpretations of the word: any of the items in the list, all of the items in the list, and any combination of the items in the list.
the singular forms “a”, “an” and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

Where a component is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of methods and apparatus have been described herein for purposes of illustration. These are only examples. The technology provided herein can be applied to contexts other than the exemplary contexts described above. Many alterations, modifications, additions, omissions and permutations are possible within the practice of this invention. This invention includes variations on described embodiments that would be apparent to the skilled person, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

The foregoing is considered as illustrative only of the principles of the invention. Thus, while certain aspects and embodiments of the invention have been described, these have been presented by way of example only and are not intended to limit the scope of the invention. Indeed, the invention described herein may be embodied in a variety of other forms without departing from the spirit of the invention, which invention is defined solely by the claims below.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. §112(f) are not to be invoked unless the specific terms “means for” or “step for” are recited in a claim.

1. A powered wheel assembly for an auger assembly, the auger assembly comprising an auger tube with an auger screw therein, a wheel support, and at least one weight-load supporting wheel rotatably mounted on the wheel support, the powered wheel assembly comprising:
a power source support structure configured for attachment to the auger assembly; and
at least one power source mounted on the power source support structure for providing a rotational force to the at least one weight-load supporting wheel;
such that actuating the at least one power source causes the at least one weight-load supporting wheel to rotate and displace the auger assembly when the power source support structure is attached to the auger assembly.

2. The powered wheel assembly of claim 1 wherein:
the auger assembly comprises two weight-load supporting wheels rotatably mounted on the wheel support; and
two power sources mounted on the power source support structure, wherein each of the weight-load supporting wheels is powered by a separate one of the power sources.

3. The powered wheel assembly of claim 2 wherein each of the power sources provides the rotational force to the corresponding weight-load supporting wheel independent of the rotational force provided by the other power source.

4. The powered wheel assembly of claim 1 wherein:
the auger assembly comprises two weight-load supporting wheels rotatably mounted on the wheel support; and
the at least one power source is one power source mounted on the power source support structure, wherein each of the weight-load supporting wheels is powered by the one power source.

5. The powered assembly of claim 1 wherein the power source support structure is configured for attachment to the support of the auger assembly.

6. The powered wheel assembly of claim 1 further comprising remote control means for controlling the at least one power source.

7. The powered wheel assembly of claim 1 wherein the at least one power source comprises a gas motor.

8. The powered wheel assembly of claim 1 wherein the at least one power source comprises an electric motor.

9. The powered wheel assembly of claim 8 wherein the electric motor is battery-powered.

10. The powered wheel assembly of claim 1 wherein the at least one power source is independent of power means for powering rotation of the auger screw of the auger assembly.

11. The powered wheel assembly of claim 1 wherein the rotational force can be in either of two directions of rotation.

12. The powered wheel assembly of claim 1 wherein the at least one power source is configured to provide variable speed to rotation of the at least one weight-load supporting wheel via the rotational force.

13. The powered wheel assembly of claim 1 further comprising a rotational force transfer arrangement for transferring the rotational force from the at least one power source to the at least one weigh-load supporting wheel.

14. The powered wheel assembly of claim 13 wherein the rotational force transfer arrangement comprises a gear assembly.

15. The powered wheel assembly of claim 14 wherein the gear assembly comprises a gear hub and a gear member.

16. The powered wheel assembly of claim 13 further comprising engaging means for selectively engaging and disengaging the rotational force transfer arrangement from the at least one weight-load supporting wheel.
